(19) United States
(12) Patent Application Publication
(10) Pub. No.: US 2013/0332910 A1
(43) Pub. Date: Dec. 12, 2013

(54) DYNAMIC LIVELOCK ANALYSIS OF MULTI-THREADED PROGRAMS

(71) Applicant: NEC Laboratories America, Inc., (US)

(72) Inventor: Malay K. Ganai, Plainsboro, NJ (US)

(73) Assignee: NEC Laboratories America, Inc., Princeton, NJ (US)

(21) Appl. No.: 13/874,890

(22) Filed: May 1, 2013

Related U.S. Application Data
(60) Provisional application No. 61/650,068, filed on May 22, 2012.

(51) Int. Cl. G06F 11/36

(52) U.S. Cl. CPC G06F 11/3692
USPC 717/131

(57) ABSTRACT

A system for analyzing a multi-threaded program includes a processor and a data storage device coupled to the processor to store a multi-threaded program execution and code for detecting one or more lock cycle conditions from the executed trace to identify one or more livelock or deadlock potentials, and code to confirm the livelock or deadlock potentials in a controlled re-execution.

The present application is a non-provisional of Provisional Application Ser. No. 61/650,068 filed May 22, 2012, the content of which is incorporated by reference.

### BACKGROUND

The present application relates to livelock analysis of multi-threaded programs.

Multi-threaded programming is error prone. The complex interaction between threads through synchronization primitives such as mutex acquires and releases can lead to a situation when one or more threads in a group do not make any forward progress (such as towards program termination).

A livelock in a multi-thread program corresponds to an undesirable situation in which computing resources are consumed by two or more threads without each making any forward progress. It is a busy-waiting analog of deadlock. Compared to deadlocks, where one or more threads are blocked forever, livelocks are harder to detect as it is not easy to distinguish between a long and an infinite busy wait (i.e., no progress) cycle.

Techniques for detecting deadlocks potentials can be broadly classified as follows: static analysis, model checking, dynamic analysis, and runtime monitoring/prevention. Static analysis tools work directly on source code, with potential of full coverage, but often result in large false positives. Dynamic analysis tools work in two phases: first, observe the trace events such as synchronization events, and then use static analysis techniques such as model checking or cycle detection schemes to identify potential deadlocks. Runtime-monitoring systems detect deadlocks in the currently executing program path. Runtime deadlock prevention systems provide mechanism (albeit at some runtime overhead) to prevent recurring deadlock situations detected previously. These techniques, as such, may not be directly applied to detect and induce livelocks, which involve much more subtle interaction between threads.

For multi-threaded programs, there are relatively a few solutions on detecting livelock potentials, in comparison with the vast literature available for detecting deadlock potentials using both static and dynamic analysis. Previous works on livelocks are based mostly on static analysis targeting concurrent programming languages such as Ada and CSP.

### SUMMARY

In one aspect, a system for analyzing a multi-threaded program includes a processor and a data storage device coupled to the processor to store a multi-threaded program and code for using one or more lock cycle conditions to detect a livelock potential, and code to confirm the livelock potential in a controlled re-execution.

In another aspect, a system is presented to identify potential livelocks by examining a trace of a program execution. From observed trace events, the system uncovers livelocks due to potentially infinite executions where one or more threads in a group are acquiring and releasing resources in busy-wait cycles to avoid deadlocks. The system can precisely detect both livelock and deadlock potentials. The system handles general locking schemes including trylocks, timedlocks, and read/write locks that are used typically in real applications. Furthermore, to confirm livelock potentials, the system generates a partial-order schedule corresponding to a livelock potential, and orchestrates a controller to induce a livelock during a program re-execution.

Advantages of the system may include one or more of the following. The system can precisely identify and classify lock cycles based on whether it can induce a deadlock or a livelock or none. The system handles general cases of mutex acquisition, where a mutex can be acquired in shared/exclusive state, and where a mutex can change between shared and exclusive without unlocking in between. Overall, the system improves the quality of multithreaded programs by exposing the potential livelock issues.

### BRIEF DESCRIPTION OF THE DRAWINGS

FIG. 1 shows an exemplary system for performing dynamic livelock analysis.

FIG. 2 shows an exemplary process for performing dynamic livelock analysis.

FIG. 3 shows an exemplary skeleton of an application that uses the SQLite engine, with a potential livelock.

### DESCRIPTION

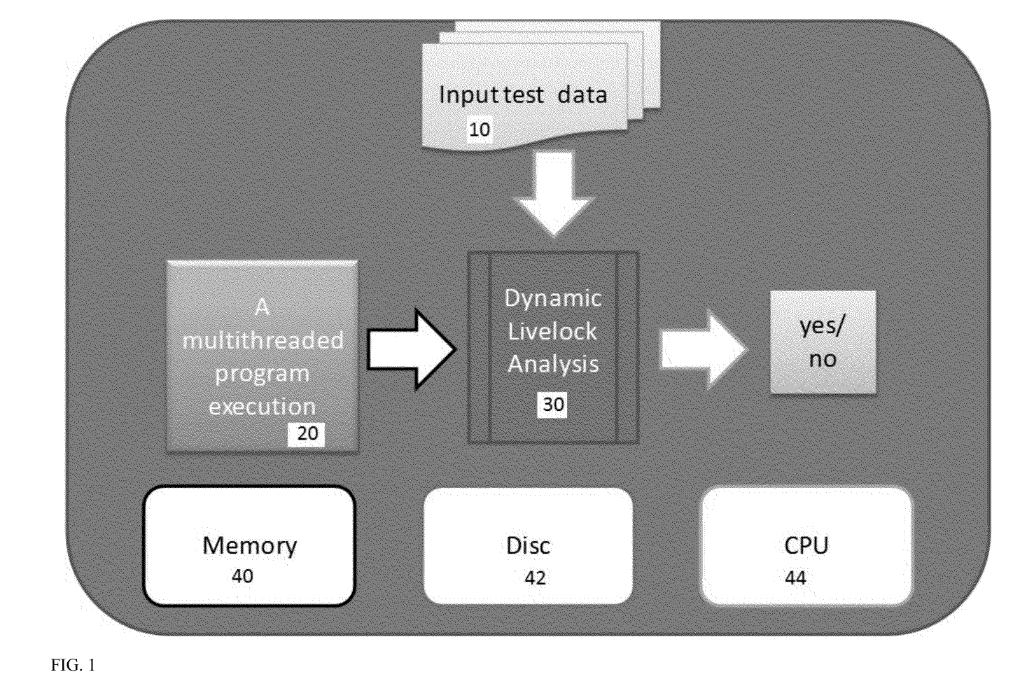

FIG. 1 shows an exemplary system for performing dynamic livelock analysis. The system receives input test data 10 and provides the input test data to a dynamic livelock analyzer 30. The analyzer 30 also receives a multi-threaded program execution 20 and generates an output. The computer of FIG. 1 is a generic simple architecture for practicing livelock analysis and that the inventive techniques could be applied to a testing of computer system whose functions or modules are spread across networks.

The system of FIG. 1 solves livelock problems that involve intra-thread cycles (such as while/for loops) and inter-thread resource request cycles. The system solves the problem in two steps. In the first step (static phase), the system focuses on finding inter-thread resource request cycles that will potentially induce intra-thread cycles. The system then identifies the necessary conditions for inter-thread cycles, which is referred to as lock cycles that correspond to either a deadlock potential or a livelock potential or none. In the second step (dynamic phase), using the lock cycle corresponding to a livelock potential, the system induces a livelock situation by replaying a partial-order schedule in such a way that the involved threads acquire and release resources without actually making any forward progress.

In one implementation, the cycle detection scheme runs with a prototype tool (CBuster) with a light-weight binary instrumentation framework for C/C++ programs to record events, and to replay partial-order schedules. The system can identify livelocks situations in a case study on an application based on SQLite, a widely used embedded multi-threaded database engine.

The multi-threaded program 20 consists of a set of concurrently executing threads T, each thread with a unique identifier t. The threads communicate with shared objects, some of which are used for synchronization such as mutexes and signals. A trace of a program π is a total ordered sequence of observed events corresponding to various thread operations on shared objects. Each event e of the sequence, i.e., e ε π is carried out by some thread, denoted as e.t, at a thread context, denoted as e.cxt . A thread context of an event corresponds to an execution state of the thread. It may comprise just a simple statement label to a more heavy weight that may comprise thread callstack and thread state. Each event e is one of the following event types, denoted as e.etype:
lock(m)/trylock(m): acquires mutex m in an exclusive state using a blocking/non-blocking call, i.e., if m is currently unavailable, lock will wait forever until it is available, while trylock will return fail if mutex is currently unavailable.
lockS(m)/trylockS(m): acquires mutex m in shared state using blocking/non-blocking call, resp. A trylockS may return fail if m is currently unavailable.
unlock(m): releasess mutex m.
wait(s)/notify(s): waits on/notifies a signal s.
fork(t′)/join(t′): forks/joins a thread child t′.
thread_start( )thread_end( ): thread starts/ends.

There could be multiple owners holding a mutex if it is in shared state, but there could be only one owner holding a mutex if it is in exclusive state. The availability/unavailability of a mutex depends on its current state. A reader/writer lock (or trylock) can be expressed equivalently using lockS/lock (or trylockS/trylock) primitives, resp. A owner holding a mutex m in a shared state can upgrade it to an exclusive state without unlocking it first, provided it is the only owner (for e.g., a file lock in Linux supports such upgrades).

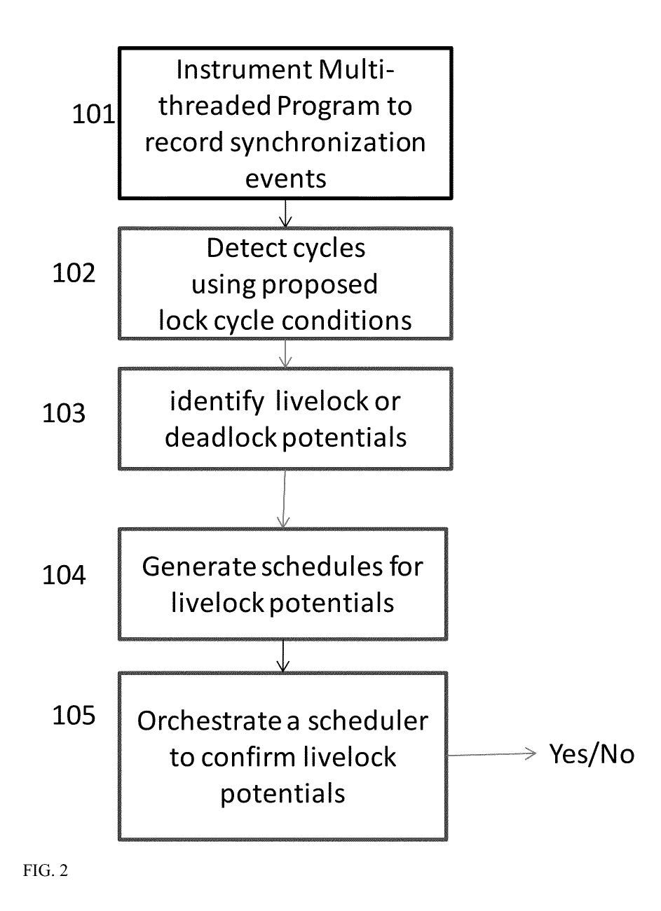

FIG. 2 shows an exemplary process for dynamic livelock analysis. First, the process instruments a multithread program to record synchronization events as observed during the execution of the program (101). From the given trace events, the process builds a lock-order graph, and check for lock cycles that satisfy the proposed cyclic dependency conditions (102). From the detected lock cycles, the process can identify the deadlock and livelock potentials precisely (103). From a lock cycle that corresponds to a livelock potential, the process generates a partial-order schedule that will induce a livelock (104). The process then orchestrates a scheduler that enforces the schedule to confirm the corresponding livelock by controlling the re-execution of the program (105). If the process succeeds to confirm, it reports “yes”; and otherwise reports “no”.

An example to identify livelock situations using dynamic analysis in three phases is discussed next.

Phase I. The system records various synchronization events such as mutex acquires/releases. A mutex acquire event lock(m) by thread t with current thread context cxt is denoted as t,cxt:lock(m). The thread context can be just a stack of call-site labels (or addresses). In the example shown, the system labels each call-site statement that invokes a lock/trylock primitive directly or indirectly. For example, context cxt₂ could be a stack of labels [Thread1: c₁, G_lock: a₂].

Phase II. Given recorded trace events, the system can search for a cyclic dependency of a set of mutexes among a group of threads such that the following conditions are satisfied:

(i) each mutex in the set is acquired by only one thread (referred as first acquire)

(ii) each thread intends to acquire another mutexe from the set (referred as second acquire)

(iii) at second acquires, no two threads hold a common mutex that was last acquired before the first acquire.

In condition (ii), if only trylock primitives (i.e., non-blocking) are used to acquire all mutexes in second acquires, we refer to such a cyclic dependencyas a trylock cycle . For the example, there exists only one trylock cycle (m₁, m₂) where t₁ (t₂) currently holds m₁ (m₂) and will acquire m₂ (m₁), resp., using trylock. Such a cycle is a livelock potential, as each thread will fail in the second acquire, but instead of blocking, it releases the mutex of first acquire, and may retry in a loop.

Approaches for detecting of deadlock potentials use conditions (i)-(ii), and a restricted (stronger) condition (iii) where no threads hold any common mutex at second acquires (i.e., at the time of acquiring the other mutex.) The stronger condition prohibits a common mutex that was last acquired after the first acquires. For the example, the lockset (i.e., the set of mutexes held by a thread) at the time t₁ acquires m₂ , and that at the time t₂ acquires m₁ have a common mutex i.e., m_{g} that was acquired after first acquires. This restriction prevents these approaches to identify the cycle (m₁, m₂) . However, these approaches can find a cycle (m₁, m_{g}) where t₁ holds m₁ and wants to acquire m_{g}, and t₂ holds m_{g} (and m₂), and wants to acquire m₁. Although such a cycle is a valid deadlock potential, a deadlock replayer (or confirmer) will fail to induce a real deadlock due to non-blocking nature of trylocks.

A cycle such as (m₁, m_{g}) may not even induce a livelock. Consider the situation where t₁ holds m₁, and t₂ holds m_{g} , m₂. Since t₁ is blocked on m_{g}, t₂ will proceed trylock-ing m₁, which it will fail, and will release m_{g} . If thread t₂ now proceeds and releases m₂ , then t₁ succeeds to acquire m_{g}, followed by m₂. In that case, t₁ does not have to retry in a loop. Thus, a livelock situation does not arise. In condition (ii), if only lock primitives are used to acquire all mutexes, then such a cyclic dependency of mutexes is called a deadlock cycle . A cycle, which is neither a trylock nor a deadlock, is referred as a mixed.

Phase III . From a detected trylock cycle, the system induces a livelock as follows. A partial-ordered schedule can be used to enforce repeatedly during an orchestrated execution. In the partial-order trace, the system first orders events {t₁,cxt₂: lock(m₁), t₂,cxt₄: lock(m₂)}, followed by {t₁, cxt₆: trylock(m₁), t₂,cxt₈: trylock(m₂)}, and followed by {t₁: unlock(m₁), t₂: unlock(m₂)}. Similarly, the system can induce a deadlock using a detected deadlock cycle.

In one embodiment, the system detects a livelock that would involve intra-thread cycles (such as while/for loops) and inter-thread resource request cycles. In the first step (static phase), the system finds inter-thread resource request cycles that will potentially induce intra-thread cycles. In the second step (dynamic phase), the system induces the livelock potentials by replaying a partial-order schedule in such a way that the involved threads acquire and release resources without actually making any forward progress.

Next, details of the three phases are discussed: (I) collection of traces, (II) identifying lock cycles , and (III) inducing livelocks.

Phase I: Collection of trace events

The program is instrumented to collect various synchronization events. Whenever a child thread is created, the system assigns a unique id i to the thread, starting from 1. The system reserves id 0 for the main thread. In the instrumentation framework, the system guarantees atomicity of fork call and setting of the child thread id. This atomicity preserves the thread creation order during replay.

The occurrence of each synchronization event is associated with a calling thread, event type, a thread context, a clock vector, and return result. The implementation assumes that only trylock/trylockS may return fail result. For re-entrant locking where a mutex can be acquired by a thread multiple times without releasing, the system records the first lock and the last unlock operations for each re-entrant mutex.

Phase II: Lock Cycles

From the collected trace events, the system constructs a set [symbol] of lock-order dependencies and a lock-order graph. For each thread t, the system starts with an empty lock-ordset [symbol] , and an empty set ELₜ of events that correspond to the acquire of mutexes in [symbol] , and process the events of t in a thread order.

For a mutex acquire event e , the system adds τ= [symbol] e.t,e.m, [symbol] [symbol] to [symbol] . The system adds a node corresponding to e.m (if it does not exist) to the lock order graph. For each n ε [symbol] , the system adds an edge from n to m with an attribute (eₙ, τ, e) where eₙ ε ELₜ is an event where mutex n is acquired. The system updates [symbol] as follows:
If mutex e.m is acquired successfully (i.e., status is success) and it is not in [symbol] , the system can append e.m to [symbol] , and add e to ELₜ. However, if e.m [symbol] (i.e., mutex status changed), the system removes the conflicting mutex from [symbol] , and the corresponding mutex acquire event from ELₜ.
If the event is unlock, the system removes the mutex e.m from the lock-ordset [symbol] , and the corresponding mutex acquire event from ELₜ.

Various optimization techniques can be used for checking DCC efficiently. These techniques reduce the graph size by removing nodes and edges that can not participate in any cycle as per DCC:(a)-(b). Since LCC:(a)-(b) are identical to DCC:(a)-(b) in the absence of lockS/trylockS , the system can use these optimization techniques. On the reduced graph, the system can adapt some of the deadlock cycle detection techniques for detecting lock cycles such as avoiding identical cycles (i.e., with same set of lock order dependencies). Once the system obtains cycles, the system can classify them into trylock, deadlock, and mixed cycles.

Phase III: Inducing Livelock

For inducing livelocks, the system can consider trylock cycles. Given such a trylock cycle, the system can first obtain a partial-order schedule of replay events, where a replay event r is defined with following attributes:
r.t: thread id
r.etype: lock/trylock/lockS/trylockS/unlock/fork
r.cxt: thread context
r.m: mutex

First three attributes of r are determined using the observed events, while the last one is obtained during replay. For a given event e, the system obtains a matching replay event r as follows: r.t:=e.t , r.etype:=e.type , and r.cxt:=e.cxt

Thread creation schedule. The system maintain same thread id across multiple runs. To do so, the system can enforce the thread creation order as observed before. Let π_{fork}=e₀ . . . eₙ₋₁ denote a total order sequence of observed fork events, where each fork event eᵢ creates a thread of id i+1. The system can obtain a corresponding sequence of replay events σ_{fork}=r₀ . . . rₙ₋₁. The system uses the partial-order sequence σ_{fork} to replay the thread creation order. Using the instrumentation framework, a call to a procedure fork_prehook is inserted just before the fork call, that takes the calling thread id, and the thread context of the fork call. If the current fork event is not scheduled, the thread waits in a loop inside fork_prehook; otherwise, it creates a child thread. Let i denote a counter that tracks the creation of threads. It is initialized to 0 when the main thread is created (which is also its id). A child thread when created, increments i by 1. The child thread then sets its id to the updated value of i, and notifies the parent. In the instrumentation framework, the system ensures atomicity of fork and the setting of child thread id to guarantee persistence of thread id across runs.

Procedure 1 fork_prehook(t, cxt)

```
  1 input: calling thread t, thread context cxt at fork
  2 global: thread id i, initialized to 0.
  3 local: Boolean flag wait
  4
  5 wait := true
  6 while (wait) do
  7  --- begin critical section
  8  if (σ_{fork}[i].cxt = cxt and σ_{fork}[i].t = t) then
  9  wait := false
10  end if
11  --- end critical section
12 end while
```

Livelock schedule. Now, the system constructs a schedule for inducing livelock for a given trylock cycle [symbol] (F₁, [symbol] t₁, m₁, [symbol] [symbol] , N₁) . . . (Fₖ, [symbol] tₖ, mₖ, Lₖ [symbol] , Nₖ) [symbol] (k>1). Let tls denote a thread local storage object visible to only that thread. It is set to following attributes for each thread tᵢ.
stateₜ_{ᵢ}: one of the following states {head, body, tail}
rhₜ_{ᵢ}: a replay event matching Fᵢ
rbₜ_{ᵢ}: a replay event matching Nᵢ
rtₜ_{ᵢ}: a replay event s.t rtₜ_{ᵢ}.t:=tᵢ and rtₜ_{ᵢ}.etype:=unlock

For unlock the system determines the corresponding mutex, which will be set during runtime. If gls denote a global storage object visible to all threads. It is set to the following attributes.
gls.state one of the following state {head, body, tail}
gls.num_pending number of threads currently pending at gls.state
gls.cycle_len length of the trylock cycle
gls.repeat count on induced cycles

Using the instrumentation framework, the system inserts a call to a procedure mutex_prehook just before the calls to mutex acquire and release events. The procedure takes following arguments: calling thread id, and the thread context of the event, event type and the mutex object.

The basic idea is as follows: There are three global states, and three thread local states. Initially, the global state gls.state is head, and stateₜ for each thread t is also head. The attributes gls.cycle_len and gls.num_pending are initialized to the length of the cycle. The state attributes gls.state/stateₜ changes from head to body to tail, and back to head cyclically. The attribute gls.repeat, initialized to 0 , keeps the count on the number of busy wait cycles induced.

If the hook is invoked while stateₜ=head, and gls.state=head, the thread is allowed to proceed with the event. Additionally, if the event matches rhₜ, then stateₜ is changed to body.

While the stateₜ=body and gls.state=head, the thread is allowed to proceed with mutex event, until it matches rbₜ. At which point, the thread is not allowed to proceed with the event; instead, the thread waits in a loop until gls.state changes to next state body . When stateᵢ for each thread t changes to body, as indicated by the attribute gls.num_pending=0 , gls.state is changed to body using next_state that simply returns the next state.

At this point, gls.state=body , and and stateₜ=body for each thread t. Transition of gls.state from body to tail is similar to its transition from head to body described above. All accesses to gls attributes are protected using a global mutex.

When the system successfully induces livelock cycles at least twice, tracked by gls.repeat, the system then reports to the user.

Procedure 2 mutex_prehook(t, cxt, etype, m)

```
  1 input: calling thread t, thread context cxt of event of type etype,
  mutex m
  2 global: global storage gls with attributes {state, num_pending,
  cycle_len, repeat}
  3 thread: local thread storage attributes {state_t, rhₜ, rbₜ, rtₜ}
  4 local: Boolean flag wait
  5
  6 repeat
  7  wait := false
  8  -- begin critical section
  9  if (stateₜ = gls.state) then
10  if (stateₜ = heat and rhₜ.cxt = cxt and rhₜ.etype = etype) then
11  stateₜ := body
12  rtₜ.m := m
13  gls.num_pending := gls.num_pending−1
14  else if (stateₜ = body and rbₜ.cxt = cxt and rbₜ.etype = etype) then
15  stateₜ := tail
16  gls.num_pending := gls.num_pending−1
17  else if (stateₜ := tail and rtₜ.m = m and rtₜ.etype = etype) then
18  stateₜ := head
19  gls.num_pending := gls.num_pending−1
20  end if
21  if (gls.num_pending = 0) then
22  gls.state := next_state(gls.state)
23  gls.num_pending := gls.cycle_len
24  gls.repeat := gls.repeat + 1
25  if gls.state = head and gls.repeat ≧ 2 then
26  “Livelock detected”
27  end if
28  end if
29  else // (stateₜ ≠ gls.state)
30  if (stateₜ = head and rhₜ.cxt = cxt and rhₜ.etype = etype) then
31  wait := true
32  else if (stateₜ = body and rbₜ.cxt = cxt and rbₜ.etype = etype) then
33  wait = true
34  else if (stateₜ = tail and rtₜ.m = m and rtₜ.etype = etype) then
35  wait := true
36  end if
37  end if
38  -- end critical section
39 until (wait = false)
```

One implementation is done in a light-weight instrumentation framework CBuster . An interposition library (in C/C++) with a LD PRELOAD facility (available in Linux) is used to instrument and control the execution of the program during runtime. The hooks fork_prehook and mutex_prehook are used to confirm the livelock potentials in the same framework. The implementation uses the thread callstack to represent the thread context.

The implementation was used to identify livelocks situations in a case study using SQLite-based application. SQlite is a popular embedded light weight database engine (written in C) that supports ACID transactions. It is used in many high-profile products: Adobe, iPhone, iPod touch, iTunes, Dropbox, Firefox. Unlike most other SQL databases, SQLite does not have a separate server process, and is built directly with client application as a single binary. SQLite reads and writes directly to ordinary disk files. A complete SQL database with multiple tables, indices, triggers, and views, is contained in a single disk file. Two application processes (on same machine) can access same database file through a separate connection.

SQLite uses reader/writer locks to control access to the databases, allowing multiple process (or threads with separate connection to database) to do read query but only one to make changes to the database at any moment in time. On Unix system, the engine uses advisory file locks fcntl to implement the reader/writer locks. Moreover, the reader/writer locking are used in non-blocking style. When SQLite tries to access the database file that is (write) locked by another process, the default behavior is to return SQLITE BUSY, thereby, preventing potential deadlocks. It also has a built-in mechanism to prevent write starvation, by disallowing new readers to acquire reader locks from the moment the writer thread is waiting for the writer lock. However, the database does not prevent potential livelocks, which can happen when two competing and conflicting transactions repeatedly compete to access the database after getting SQLITE_BUSY errors.

SQLite supports two modes of atomic commit and rollback: rollback journal and Write-ahead-logging (WAL). This case study considers the rollback journal mode. In this mode, the database is in one of the five lock states unlock, shared, reserved, pending, and exclusive. The database accesses are coordinated using three distinct flock: flock_P, flock_R, and flock_D corresponding to pending, reserved, and database locks. In unlock state, a thread cannot access a database. To get a read access, it has to first acquire the mutex flock_P in a shared state, followed by mutex flock_D in a shared state. It releases the mutex flock_P so that the mutex can be acquired in exclusive state when needed. Multiple reader threads can acquire flock_D in shared state similarly. If a thread wants to write, it has to acquire the mutex flock_R in exclusive state. If it succeeds, the database goes into reserved lock state. Only one thread can acquire mutex flock_R. While the database is in reserved lock state, new reader threads can still acquire mutex flock_D in shared state. The writer thread, while holding flock_R in exclusive state, acquires the mutex flock_P in exclusive state, and prevents new readers. This mechanism prevents writer starvation as no new shared lock will be granted. Once the database is in the pending state, the writer thread attempts to acquire mutex flock_D in exclusive state. Once the writer obtains the exclusive lock, it updates and commits the changes to database, releases all the mutexes i.e., flock_D, flock_P, flock_R. If the database is in shared state (i.e., flock_D is still held by some thread) while an exclusive lock flock_D is requested, SQLITE_BUSY error is returned to the application; in which the application has to rollback and retry the SQL request.

The flocks are acquired/released through F_SETLK command in the function call fcntl. The call with this command is non-blocking, and simply returns success/fail, like trylock . In the implementation, the system extends mutex handling of flocks by uniquely identifying them. Further, the calls are instrumented to fnct1 to record the acquisition and release of flocks, and then classify them as trylock/trylockS/unlock events.

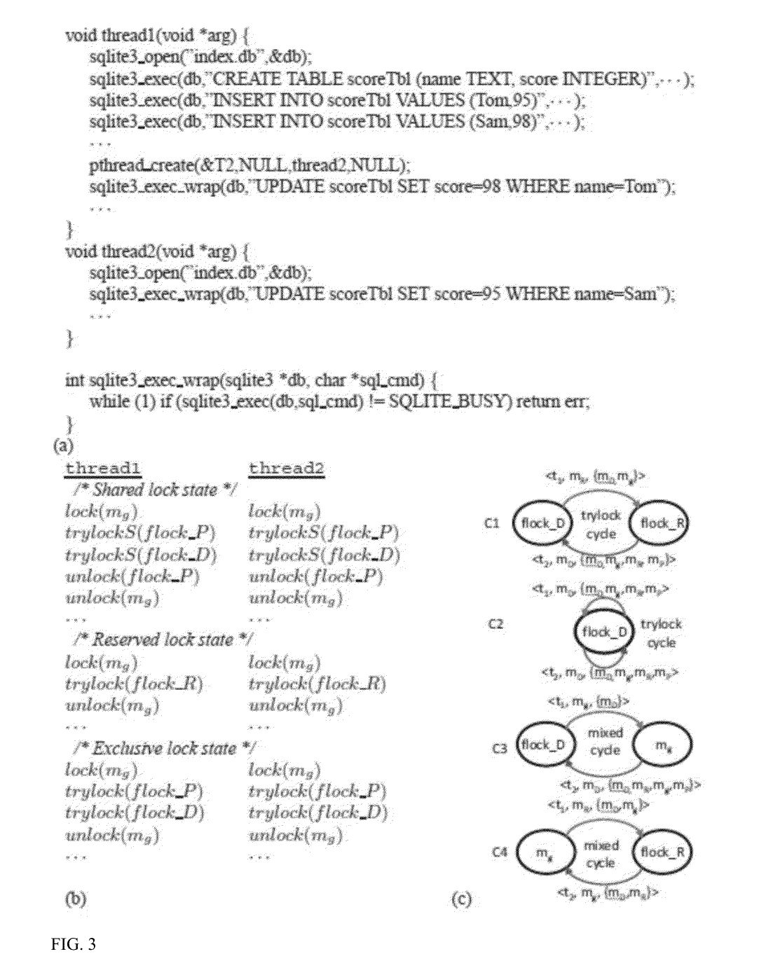

FIG. 3 shows an exemplary skeleton of an application that uses the SQLite engine, with a potential livelock. The code is shown in (a) with two threads, thread1 (t₁) and thread2 (t₂), both access a common database file through separate connections. First thread creates a table object scoreTb1 , and inserts two rows, before creating the second thread. After thread creation, both threads try to update the database concurrently. Each thread calls sqlite3_exec in a while loop with in a wrapper function to ensure that the updates succeeds eventually. In multiple runs of the code, both threads succeed in 0-2 retrials most of the time.

In (b), the sequence of relevant lock/trylock primitives is shown in a good serialized trace of each thread (shown side-by-side) as collected by the tool CBuster. The system then searches for all lock cycles that satisfy LCC. Note, due to happens-before condition requirement LCC: (c), the system does not generate any spurious cycles between INSERT and UPDATE queries. The system then detects a total of 10 lock cycles between the two UPDATE queries (which are not causally ordered). The system groups them if they have identical lock-order dependency chain with matching thread contexts of Fᵢ and Nᵢ events.

Out of 10 lock cycles, 4 of them are trylock cycles and are grouped into C1; another 4 of them are also trylock cycles and are grouped into C2; and the remaining are mixed cycles, C3 and C4, as shown in (c). mₚ is a shorthand notation for the mutex flock_D. Similarly, m_{D} , and m_{R}.

In C1 cycle, t₁ acquires flock_D in shared state, and then tries to get flock_R in exclusive state; while t₂ first acquires flock_R in exclusive state, and tries to get flock_D in exclusive state. The corresponding lock order dependency chain is [symbol] t₁, m_{R}, {m_{D}, m_{g}} [symbol] , [symbol] t₂, m_{D}, {m_{D}, m_{g}, m_{R}, m_{P}} [symbol] . A mutex is underlined if it is acquired in shared state. The lock-ordsets m_{D}. {m_{D}, m_{g}}={m_{D}} and m_{R}. {m_{D}, m_{g}, m_R, m_{P}}={m_{D}, m_{g}, m_{R}} do not intersect. LCC:(a)-(d) are satisfied, and hence, it is valid lock cycle. Furthermore, the system was also able to induce livelocks for all the four trylock cycles in C1 group using the scheduler, as discussed in Section 5.3.

In C2 cycle, t₁ and t₂ both acquire flock_D in shared states, then try to get flock_D in exclusive state. The corresponding lock order dependency chain is [symbol] t₁, m_{D}, {m_{D}, m_{g}, m_{g}, m_{P}} [symbol] , [symbol] t₂, m_{D}, {m_{D}, m_{g}, m_{g}, m_{P}} [symbol] . All LCC conditions are satisfied, and therefore, it is a valid lock cycle. The system was also able to induce livelocks for the four trylock cycles in this group. The scheduler, when applied to mixed cycles C3, and C4, successfully forces one thread to retry.

The foregoing in-depth case study shows the usefulness of the system in detecting and confirming livelocks potentials in real application which can occur in intricate interactions between third-party library and user application.

The dynamic livelock analysis framework for multi-thread programs can identify livelock potentials by examining a single execution trace of the program, and then induce a livelock by orchestrating a scheduler on a re-execution of the program. The cycle detection scheme can be used to identify both deadlock and livelock potentials precisely in the presence various of mutex acquire schemes. The present inventors contemplate that the instant system can be used to solve similar livelock issues occur in the intricate interaction between application and third-party modules.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method for analyzing a multi-threaded program, comprising:
detecting cyclic dependency of a set of mutexes acquired among a group of threads wherein:
each mutex in the set is acquired by only one thread corresponding to the first acquires,
each thread intends to acquire another mutex from the set corresponding to the second acquires, and
no two threads hold a common mutex that was last acquired before the first acquires;
identifying detected dependency cycles as livelock or deadlock potentials;
generating one or more schedules for one or more livelock or deadlock potentials; and
running a scheduler to confirm the one or more livelock or deadlock potentials.

2. The method of claim 1, comprising identifying livelock potentials wherein all mutexes at second acquires is acquired using non-blocking primitives only.

3. The method of claim 1, comprising identifying deadlock potentials wherein all mutexes at second acquires is acquired using blocking primitives only.

4. The method of claim 1, comprising acquiring mutexes in a shared or an exclusive state.

5. The method of claim 1, comprising changing the mutexes between shared and exclusive state without a release in between.

6. The method of claim 1, comprising analyzing an execution trace of a multi-thread program.

7. A system for analyzing a multi-threaded program, comprising:
a processor;
computer readable code executed by the processor for detecting cyclic dependency of a set of mutexes acquired among a group of threads wherein:
each mutex in the set is acquired by only one thread corresponding to the first acquires,
each thread intends to acquire another mutex from the set corresponding to the second acquires, and
no two threads hold a common mutex that was last acquired before the first acquires;
computer readable code executed by the processor for identifying detected dependency cycles as livelock or deadlock potentials;
computer readable code executed by the processor for generating one or more schedules for one or more livelock or deadlock potentials; and
computer readable code executed by the processor for running a scheduler to confirm the one or more livelock or deadlock potentials.

8. The system of claim 7, comprising computer readable code executed by the processor for identifying livelock potentials wherein all mutexes at second acquires is acquired using non-blocking primitives only.

9. The system of claim 7, comprising computer readable code executed by the processor for identifying deadlock potentials wherein all mutexes at second acquires is acquired using blocking primitives only.

10. The system of claim 7, comprising computer readable code executed by the processor for acquiring mutexes in a shared or an exclusive state.

11. The system of claim 7, comprising computer readable code executed by the processor for changing the mutexes between shared and exclusive state without a release in between.

12. The system of claim 7, comprising computer readable code executed by the processor for analyzing an execution trace of a multi-thread program.
